(19) United States
(12) Patent Application Publication
(10) Pub. No.: US 2026/0168806 A1
(43) Pub. Date: Jun. 18, 2026

(54) METHOD FOR COLLECTING ROUTE DATA AND AN APPARATUS THEREOF

(71) Applicant: HYUNDAI AUTOEVER CORP., Seoul (KR)

(72) Inventors: Nam Ji Bang, Seoul (KR); Hee Eun Lee, Seoul (KR); Ye Won Seol, Seoul (KR); Yeon Su Kim, Seoul (KR); Jung Yong Kim, Seoul (KR); Da Eun Joung, Seoul (KR)

(73) Assignee: HYUNDAI AUTOEVER CORP., Seoul (KR)

(21) Appl. No.: 19/416,720

(22) Filed: Dec. 11, 2025

(30) Foreign Application Priority Data
Dec. 18, 2024 (KR) 10-2024-0189765

(51) Int. Cl. G01C 21/36; G06V 20/58

(52) U.S. Cl. CPC G01C 21/3602; G01C 21/3664; G06V 20/58

(57) ABSTRACT

A method for collecting route data includes detecting that a vehicle drives on a second road link, instead of driving on a first road link included in an existing route provided by a navigation device, by passing through a first junction node included in the existing route. The method also includes requesting a user of the navigation device to confirm whether the first road link should be excluded from road link candidates available for selection in determining routes. The method additionally includes determining whether to exclude the first road link from the road link candidates, based on a response to the request received from the user.

### CROSS-REFERENCE TO RELATED APPLICATION

This application claims the benefit of and priority to Korean Patent Application No. 10-2024-0189765, filed on Dec. 18, 2024, the entire contents of which are hereby incorporated herein by reference.

### TECHNICAL FIELD

The present disclosure relates to a method for collecting route data and an apparatus thereof.

### BACKGROUND

The statements in this section merely provide background information related to the present disclosure and may not constitute prior art.

A navigation system guides a route for a user to move to a destination, and may provide a route that includes a road on which a vehicle may not drive at a specific time zone or situation. For example, as shown in FIG. 2, according to an existing route of a vehicle 20, the vehicle 20 drives on a first road 32, but when the vehicle 20 cannot drive on the first road 32 due to construction at a certain point 34 of the first road 32, a driver may drive on a second road 33 instead of the first road 32.

The driver may report an unavailable (e.g., impassible) road included in a route provided by the navigation system when discovering the unavailable driving road. This reported information may be utilized to exclude the unavailable road from subsequent routes. For example, as shown in FIG. 2, the driver of the vehicle 20 may report that construction is underway on the first road 32, through a navigation terminal.

However, the conventional reporting system may be designed in such a manner that the driver should directly report the corresponding information. Since this reporting method does not provide high convenience to the driver, there may be a problem of low actual participation.

### SUMMARY

Aspects of the present disclosure provide a technology that automatically collects data on unavailable (e.g., impassible) roads and enhances convenience to induce driver's participation.

Aspects of the present disclosure to provide a method and an apparatus for automatically collecting information on unavailable (e.g., impassible) roads among roads included in a route provided to a user of a navigation terminal.

Aspects of the present disclosure provide a method and an apparatus for automatically determining an unavailable (e.g., impassible) road by using a driver's driving history, image data on a road, and/or the driver's voice data.

Aspects of the present disclosure provide a method and an apparatus for improving convenience of a vehicle driver when reporting route guidance errors or unavailable (e.g., impassible) roads.

The objects of the present disclosure are not limited to those mentioned above. Other objects of the present disclosure, that are not mentioned herein, should be more clearly understood by those having ordinary skill in the art from the following description of the present disclosure.

According to an aspect of the present disclosure, a method for collecting route data is provided. The method includes detecting that a vehicle drives on a second road link, instead of driving on a first road link included in an existing route provided by a navigation device, based on detecting that the vehicle passes through a first junction node included in the existing route. The method also includes requesting a user of the navigation device to indicate whether the first road link should be excluded from road link candidates for selection in determining routes for vehicles. The method additionally includes determining whether to exclude the first road link from the road link candidates based on a response to the request.

In some embodiments, requesting the user to confirm whether the first road link should be excluded from the road link candidates may include requesting a driver of the vehicle to confirm whether the first road link should be excluded from the road link candidates based on determining that the vehicle have driven on the second road link instead of the first road link a preset number of times or more.

In some embodiments, determining whether to exclude the first road link from the road link candidates may include: acquiring image data on the first road link; and determining to exclude the first road link from the road link candidates based on determining that the acquired image data includes an object of a preset type.

In some embodiments, determining whether to exclude the first road link from the road link candidates may include: acquiring image data on the first road link; and determining to exclude the first road link from the road link candidates by comparing the acquired image data with reference image data on the first road link.

In some embodiments, the reference image data on the first road link may be acquired at a time when the vehicle drives on the first road link.

In some embodiments, the method may further include: generating information related to a reason why the first road link is excluded from the road link candidates, based on the image data on the first road link; and adding information related to the reason why the first road link is excluded from the road link candidates to the data on the first road link.

According to another aspect of the present disclosure, a method for collecting route data is provided. The method includes detecting that a vehicle drives on a second road link, different from a first road link, instead of driving on the first road link included in an existing route provided by a navigation device, at a first junction node included in an existing route provided by the navigation device. The method also includes acquiring a voice utterance of a user of the navigation device. The method additionally includes excluding the first road link from road link candidates available for selection in determining routes, based on determining that the voice utterance includes an utterance of a preset type.

In some embodiments, acquiring the voice utterance of the user of the navigation device includes acquiring a voice utterance of a driver of the vehicle within a preset time from a time of detecting that the vehicle has not entered the first road link.

In some embodiments, acquiring the voice utterance of the user of the navigation device includes acquiring the voice utterance of the user of the navigation device before detecting that the vehicle has not entered the first road link.

In some embodiments, the method may further include: detecting that the vehicle has not entered the first road link after the first road link is excluded from the road link candidates; and generating a message including information on the first road link.

In some embodiments, excluding the first road link from the road link candidates includes: acquiring image data on the first road link; and excluding the first road link from the road link candidates based on determining that the voice utterance of the user matches the image data.

In some embodiments, the method may further include acquiring data on the first road link based on the image data; and generating a message including information on the first road link based on the data on the first road link.

In some embodiments, the method may further include generating data related to a reason why the first road link is excluded from the road link candidates, based on the voice utterance of the user.

According to the other aspect of the present disclosure, an apparatus for collecting route data is provided. The apparatus includes a memory configured to store computer-readable instructions, and one or more processors configured to execute the computer-readable instructions. The one or more processors are configured to detect that a vehicle drives on a second road link, different from a first road link, instead of driving on the first road link included in an existing route provided by a navigation device, at a first junction node included in the existing route provided by the navigation device. The one or more processors are also configured to request a user of the navigation device to indicate whether the first road link should be excluded from road link candidates available for selection in determining routes. The one or more processors are additionally configured to determine whether to exclude the first road link from the road link candidates, based on image data on the first road link, in response to receiving a response from the user indicating that the first road link should be excluded from the road link candidates.

### BRIEF DESCRIPTION OF THE DRAWINGS

The above and other aspects and features of the present disclosure should become more apparent from the following detailed description taken in conjunction with the accompanying drawings, in which:

FIG. 1 is a schematic view illustrating a configuration of an apparatus for collecting route data according to an embodiment of the present disclosure;

FIG. 2 is a view illustrating a situation to which some embodiments of the present disclosure are applied;

FIG. 3 is a flow chart illustrating a method for collecting route data according to an embodiment of the present disclosure;

FIGS. 4-11 are detailed views illustrating the method described with reference to FIG. 3, according to embodiments of the present disclosure;

FIG. 12 is a flow chart illustrating a method for collecting route data according to another embodiment of the present disclosure;

FIGS. 13-15 are detailed views illustrating the method described with reference to FIG. 12, according to embodiments of the present disclosure; and

FIG. 16 is a block diagram illustrating a hardware configuration of a computing device used in some embodiment of the present disclosure.

### DETAILED DESCRIPTION

Hereinafter, embodiments of the present disclosure are described with reference to the accompanying drawings. Advantages and features of the present disclosure and methods of accomplishing the same should be more clearly understood from the following detailed description taken in conjunction with the accompanying drawings. The present disclosure may, however, be embodied in many different forms and should not be construed as being limited to the embodiments set forth herein. Rather, these embodiments are provided to make the present disclosure thorough and complete and to fully convey the concept of the present disclosure to those having ordinary skill in the art, and the present disclosure is defined only by the appended claims.

When a component, controller, device, element, apparatus, unit, or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

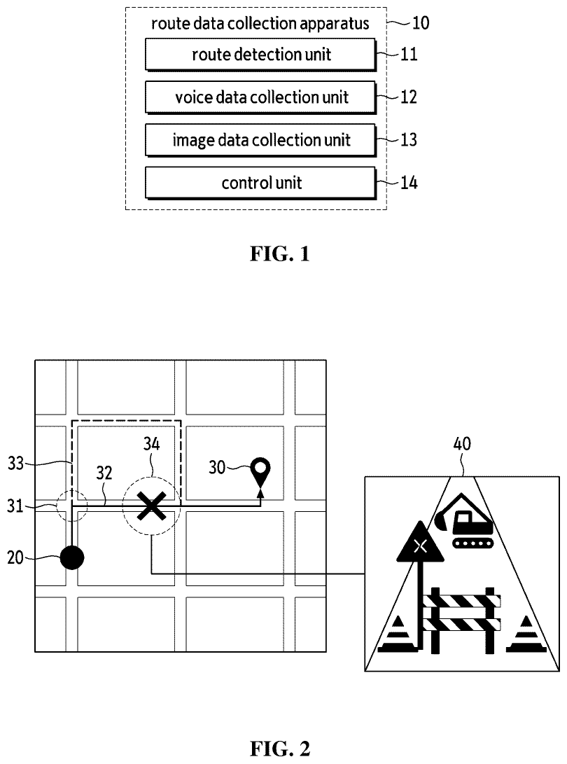

A configuration and operation of an apparatus for collecting route data according to an embodiment of the present disclosure is described with reference to FIG. 1. FIG. 1 is a schematic view of a configuration of an apparatus for collecting route data according to an embodiment of the present disclosure.

An apparatus 10 for collecting route data (also referred to herein as a “route data collection apparatus”) may include at least one of a route detection unit 11, a driver voice data collection unit 12, an image data collection unit 13, or a control unit 14.

The route detection unit 11 may detect that a vehicle is deviating from an existing route. For example, as shown in FIG. 2, in order to reach a destination 30, a vehicle 20 may make a right turn at a junction node 31 to drive on a first road link 32, or may go straight and drive on a second road link 33. In this case, the existing route may be a route in which the vehicle should drive from the junction node 31 to the first road link 32 so that a driving distance of the vehicle becomes the shortest distance. As shown in FIG. 2, the first road link 32 may be a road where driving is impossible due to the presence of a section 34 in which access is restricted due to construction. The driver cannot drive to the first road link 32, and thus may drive to the second road link 33. In this case, the route detection unit 11 may detect driving on the second road link 33 instead of the first road link 32 included in the existing route.

The above-described junction node and the road link may mean basic components for expressing a structure of a road network. In detail, the junction node may represent a point at which roads intersect or join within the road network. For example, the junction node may be an intersection, a highway start and end point, a bridge start and end point, an overpass start and end point, or a tunnel start and end point. The start and end point means a start point and an end point of a specific road. In addition, the road link may indicate a road section connecting the junction nodes. The road link may be represented by linear data connecting two junction nodes in a straight line. The road link may include various attributes such as an actual physical shape, a length, a direction and the number of lanes of the road, a speed limit, and whether driving is currently possible. The navigation device may determine a route by selecting a junction node and a road link so as to reach a destination from a departure point. Hereinafter, for convenience of description, what is described as a road link may be understood as an actual road corresponding to the road link, and what is described as a junction node may be understood as an actual junction location corresponding to the junction node.

The voice data collection unit 12 may collect voice data of a driver who is a user of a navigation device for providing a route or a passenger of a vehicle equipped with the navigation device. In an embodiment, collecting voice data may mean acquiring a voice of the user of the navigation device, that is uttered under a predetermined condition. When a route deviation is detected, the voice data collection unit 12 may collect voice data. In addition, the voice data collection unit 12 may present the user with a question (e.g., should I register it as an accident point?) by a voice and collect voice data when the user's response (e.g., yes, or no) to the question is detected. The voice data collection unit 12 may perform all operations of acquiring voice data necessary for some embodiments of the present disclosure.

When a route deviation is detected, the image data collection unit 13 may acquire image data on a road link on which the vehicle does not drive due to the route deviation. The image data may mean data composed of at least one image. For example, the image data may include a plurality of images consecutively acquired. In an embodiment, for example, the image data may include video data. The image data collection unit 13 may perform all operations of acquiring image data necessary for some embodiments of the present disclosure

For example, as shown in FIG. 2, when the vehicle 20 deviates from a route and drives on the second road link 33 instead of the first road link 32 at the junction node 31, the image data collection unit 13 may acquire an image 40 for the first road link. In addition, the image data collection unit 13 may recognize a specific object (e.g., excavator, no-entry sign, traffic cone, or no-entry fence) from the acquired image 40, and may add information on the recognized object to the image data.

The control unit 14 may determine whether the road link is a road link on which the vehicle cannot drive or the vehicle's driving is not desired, by using the data (e.g., user voice data, and image data on the first road link) acquired from the above-described components and whether a route deviation is detected. Also, when the control unit 14 determines that the road link is a road link on which the vehicle cannot drive or the vehicle's driving is not desired, the control unit 14 may exclude the road link from road link candidates. The road link candidates may mean a plurality of road links that may be selected to determine a route.

For example, as shown in FIG. 2, when the vehicle 20 deviates from the route and drives on the second road link 33 instead of the first road link 32 at the junction node 31, the control unit 14 determines that the first road link 32 is a road link on which the vehicle cannot drive due to construction, through the user's voice data (e.g., It is under construction) and the image data (e.g., image including an object of an excavator, no-entry sign, or a traffic cone) for the first road link, and may exclude the first road link 32 from the road link candidates.

It should be noted that the operations of the components of the route data collection apparatus are not limited to the above-described example. For example, the operations may include operations related to a route data collection method according to some embodiments of the present disclosure that are described in more detail below. In addition, technical spirits that may be grasped through embodiments of the present disclosure described in more detail below may be applied to the route data collection apparatus described above even where there is no separate description.

In addition, the route data collection methods according to embodiments of the present disclosure may be performed by one or more computing devices. For example, a route data collection method according to an embodiment may be performed by two or more computing devices. In an embodiment, some operations included in the route data collection method may be performed by a first computing device, and the other operations included in the route data collection method may be performed by a second computing device.

The computing device may be a computing device (e.g., a navigation terminal embedded in the vehicle) provided in the vehicle equipped with the route data collection apparatus described with reference to FIG. 1, or may be a computing device (e.g., server, or smartphone) separate from the vehicle. In the following description, the subject of a specific step/operation may be omitted, and in this case, it may be understood that the step/operation is performed by the computing device.

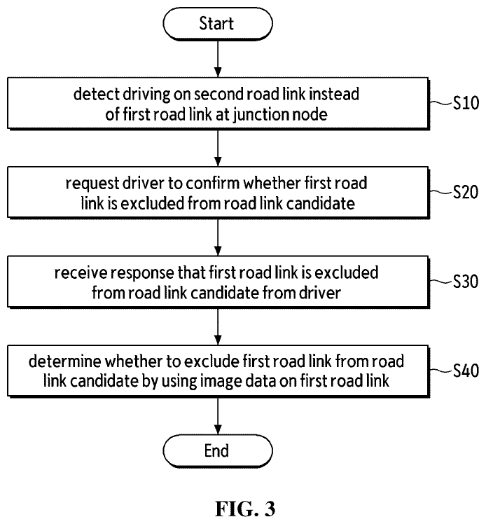

The components of the route data collection apparatus according to an embodiment of the present disclosure have been described as above with reference to FIGS. 1 and 2. Hereinafter, route data collection methods and devices according to some embodiments of the present disclosure are described with reference to FIGS. 3-20.

FIG. 3 is a flow chart of a route data collection method according to an embodiment of the present disclosure.

Referring to FIG. 3, in an operation S10, it may be detected that a vehicle that is driving has driven on a second road link, instead of a first road link that is included in an existing route, at a junction node included in the existing route. The second road link may be a road link that is connected to the junction node and is different from the first road link.

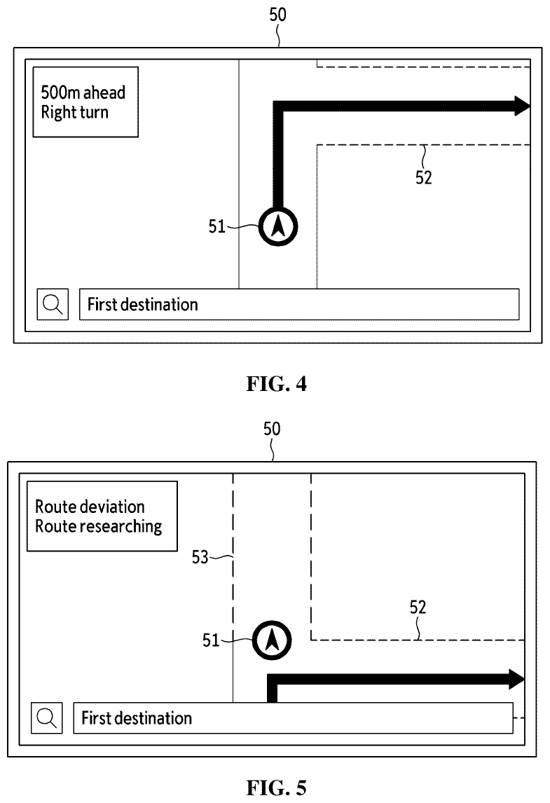

For example, the existing route of a vehicle 51 may be a route on which the vehicle 51 makes a right turn and drives on a first road link 52, as shown a screen 50 of a navigation terminal illustrated in FIG. 4. Subsequently, as shown on the screen 50 of the navigation terminal illustrated in FIG. 5, it may be detected that the vehicle 51 deviates from the existing route and drives on a second road link 53. Accordingly, it may be detected that the vehicle has driven on the second road link instead of the first road link at the junction node, based on that the route deviation being detected by the navigation terminal.

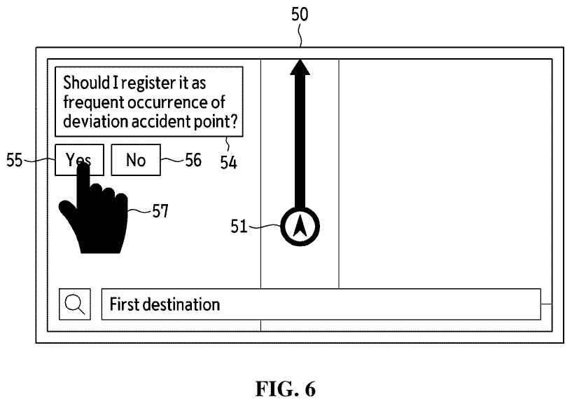

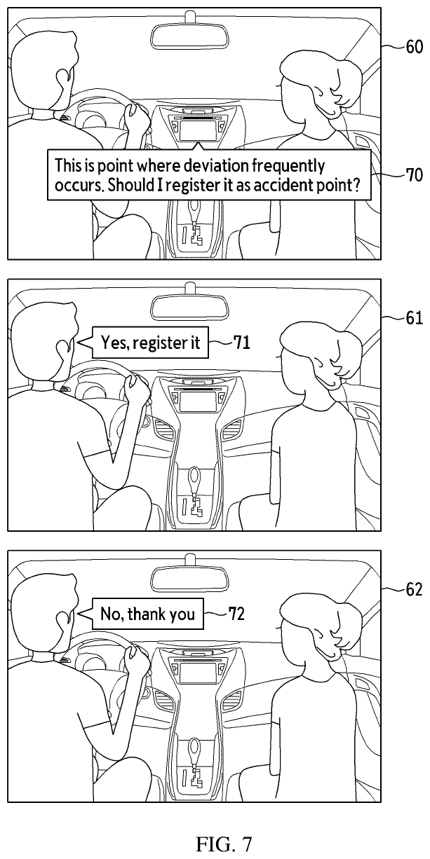

Referring back to FIG. 3, in an operation S20, the driver of the vehicle may be requested to confirm whether to exclude the first road link from the road link candidate. For example, when the vehicle 51 deviates from the route without driving on the first road link, as illustrated in the screen 50 of the navigation terminal shown in FIG. 6, confirmation as to whether to register the first road link as an accident point may be requested f the driver. As shown in FIG. 6, a confirmation request 54 may be displayed on a display. As another example, as shown in a view 60 illustrated in FIG. 7, the confirmation request may be output as a voice 70.

Referring back to FIG. 3, in an operation S30, a response that the first road link should be excluded from the road link candidates may be received from the driver. The response that the first road link should be excluded from the road link candidates may be received through a user's voice or a user's input to a display.

For example, as shown on the screen 50 of the navigation terminal illustrated in FIG. 6, the user may touch 57 a button 55 displayed on the display of the navigation terminal to register the first road link, on which the vehicle has not driven due to the route deviation, as an accident point. On the other hand, the user may not register the first road link as an accident point by touching a button 56 displayed on the display of the navigation terminal. Also, as shown in a view 61 illustrated in FIG. 7, the user may register the first road link as an accident point by a voice 71. On the other hand, as shown in a view 62 illustrated in FIG. 7, the user may not register the first road link as an accident point by a voice 72.

Referring back to FIG. 3, in an operation S40, whether to exclude the first road link from the road link candidates may be determined by additionally using the image data on the first road link. The image data on the first road link may include an image or video obtained by photographing a road corresponding to the first road link.

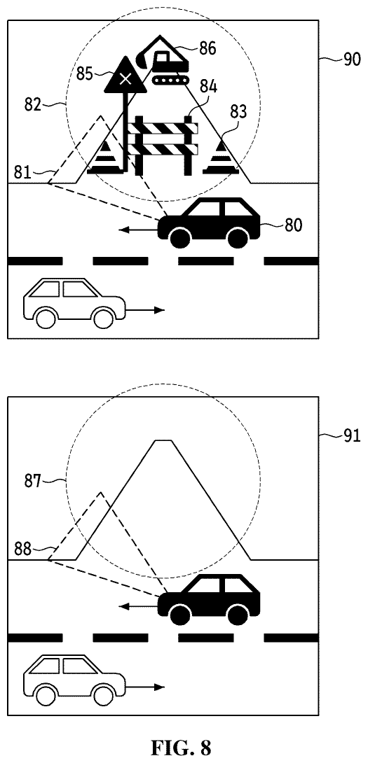

For a detailed example, as shown in FIG. 8, when a camera module included in a vehicle 90 detects deviation of the existing route, an image of the first road may be acquired by photographing 81 a road (hereinafter, referred to as a first road) corresponding to the first road link that is included in the existing route and on which the vehicle does not drive. The first road may be a road which the vehicle cannot enter because construction is in progress, as shown in a view 80. When an image on the first road is acquired, and a traffic cone 83, a no-entry panel 84, a no-entry sign 85, or an excavator 86, which is an object related to inaccessibility, is recognized from the image on the first road, the first road may be determined as a road on which the vehicle cannot drive. When the first road 82 is determined as a road on which the vehicle cannot drive, it may be determined that the first road link is excluded from the road link candidate.

Accordingly, in an embodiment, whether or not to exclude the first road link from the road link candidates may be determined based on whether an object (e.g., a preset type of object) for which the first road link should be excluded from the link candidates is included in the image data on the first road link. For example, the object that may indicate that the first road link should be excluded from the road link candidates may include at least one of a traffic cone, a no-entry panel, a construction panel, a no-entry sign, a construction sign, a jammed vehicle, a vehicle involved in accident, an excavator, a tow truck, or an ambulance, which make road driving impossible.

In an embodiment, determining whether to exclude the first road link from the road link candidates by using the image data on the first road link may be determined by comparing image data of a case that the vehicle drives on the first road link at the first junction node with image data of a case that the vehicle doesn't drive on the first load link at the first junction node. For example, as shown in FIG. 8, it may be assumed that an example 90 is the case that the vehicle does not drive on the first road link and an example 91 is the case that the driver drives on the first road link. In this case, when the vehicle drives on the first road link, the image data on the first road link may be acquired. In addition, when the vehicle does not drive on the first road link, the image data on the first road link may be acquired. As a result of comparing the two acquired image data, when the vehicle does not drive on the first road link, an object such as a traffic cone, a no-entry sign, a no-entry panel and an excavator may be identified, unlike when the vehicle drives on the first road link. Since a difference occurs in the two image data, when the vehicle does not drive on the first road link, it may be determined that the first road link is excluded from the road link candidate.

In an example 91 shown in FIG. 8, a first road 87 is a road that is sufficiently accessible to the vehicle, and the vehicle may not drive on the first road 87 due to a mistake in the route or a simple change of mind. When the vehicle deviates from the route without driving on the first road, an image of the first road is acquired by photographing 88 the first road, and since an object related to inaccessibility is not recognized from the image of the first road, the first road may be determined as a road on which the vehicle may drive. When the first road is determined as a road on which the vehicle may drive, it may be determined that the first road link is not to be excluded from the road link candidate.

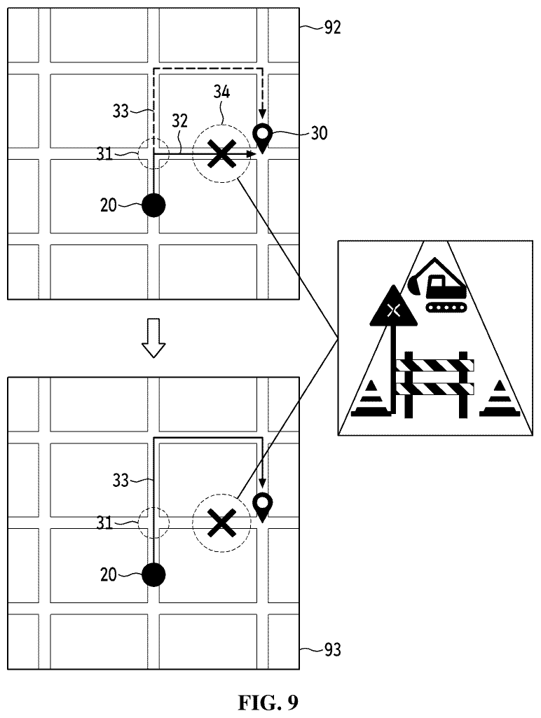

When the first road link is excluded from the road link candidates, only road links other than the first road link may be selected to determine the route of the vehicle. In addition, when determining a route in another vehicle different from the above vehicle, only the road links other than the first road link may be selected to determine the route. The above vehicle and another vehicle different from the above vehicle may be vehicles that use the same navigation system. For example, as shown in a view 92 illustrated in FIG. 9, at one point 34 of the first road link 32 included in the existing route to the destination 30 of the first vehicle 20, the vehicle cannot enter the point due to construction in progress. In this case, the first road link 32 may be excluded from the road link candidates in accordance with the above-described method. Afterwards, as shown in a view 93 illustrated in FIG. 9, when a second vehicle 21 is provided with a route to the same destination 30, a route including the second road link 33 instead of the first road link 32 may be provided at the junction node 31. In addition, when the first vehicle 20 is subsequently provided with a route to the same destination, a route including the second road link 33 instead of the first road link 32 may be provided at the junction node 31.

In summary, in embodiments of the present disclosure, when a vehicle deviates from a route, a driver of the vehicle may be requested to indicate whether to exclude a road link, on which the vehicle does not drive due to route deviation, from road link candidates, and whether to exclude the road link from the road link candidates may be determined based on the driver's response and an image of the corresponding road link.

Receiving a request for confirmation as to whether to exclude the first road link from the road link candidates through the above-described method whenever a route deviation is detected may cause fatigue to the user.

Therefore, in another embodiment, the above-described method is not applied whenever the route deviation is detected, and may be applied when the number of times of route deviation from the first road link to the second road link at the corresponding junction node satisfies a preset threshold condition (e.g., exceeds a preset number of times).

For a detailed example, as shown in FIG. 2, when construction is in progress at one point 34 of the first road link 32 included in the existing route of the vehicle 20, the vehicle 20 may initially drive on the second road link 33 instead of the first road link 32 in order to avoid the point 34 at which construction is in progress. When the vehicle initially deviates from the first road link 32 to the second road link 33, the request for confirmation as to whether to exclude the first road link 32 from the road link candidates may not occur. Afterwards, when the vehicle 20 drives on the second road link 33 instead of the first road link 32 once more, the request for confirmation as to whether to exclude the first road link 32 from the road link candidates may occur.

Accordingly, in an embodiment, when vehicles with the same destination deviate from the route by avoiding the same road link more than a preset number of times at the same junction node, the request for confirmation as to whether to exclude the corresponding road link from the road link candidates may occur.

The vehicles with the same destination may mean a plurality of vehicles that use the same navigation system, rather than necessarily meaning one vehicle. For example, a first vehicle may initially drive on the second road link instead of the first road link at the first junction node, and a second vehicle having the same destination may drive on the second road link instead of the first road link at the first junction node. In this case, the driver of the second vehicle initially deviates from the route, but a request for confirmation as to whether to exclude the first road link from the road link candidates may occur to the driver of the second vehicle.

In addition, it should be noted that the preset number of times is not limited to the above-mentioned twice. The preset number of times may be determined (e.g., automatically determined) based on the cause of the route deviation, information on the junction where the route deviation occurs, the timing point when the route deviation occurs, and/or whether the corresponding road link has been previously excluded from road link candidates. For example, when the cause of the route deviation is determined to be that a place where there is no road is recognized as a road due to an error of route data itself, the preset number of times may be determined to be lower than in other cases. As another example, when the junction where the route deviation has occurred is a place where it is difficult to change lanes (e.g., road junction), and when the route deviation may be caused by the driver's inexperienced driving, the preset number of times may be determined to be higher than in other cases.

When the first road link is excluded from the road link candidates, information on why it is excluded from the road link candidates may be stored in the data on the first road link together with information on content that it is excluded from the road link candidate.

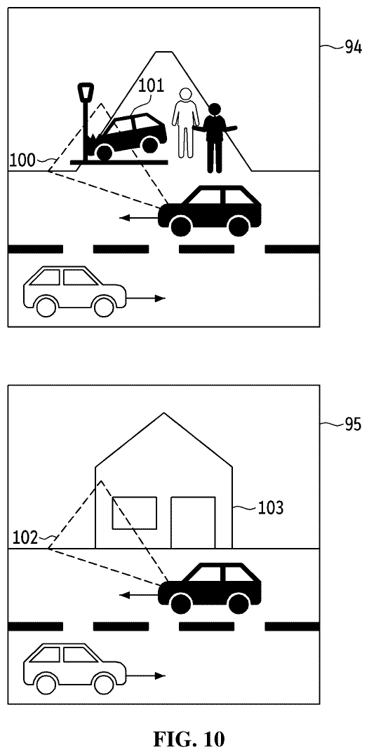

For example, as shown in a view 94 illustrated in FIG. 10, when image data on the first road link is acquired by photographing a first road but includes an image of a vehicle 100 in which an accident has occurred, the reason why the first road link was excluded from the road link candidates may be stored as the occurrence of a traffic accident. In addition, since the inability to drive on the first road link due to the occurrence of a traffic accident is temporary, information on the period during which the first road link is excluded from the road link candidates may be also acquired. For example, considering the time it takes for the traffic accident to be resolved, the first road link may be excluded from the road link candidates before the time the traffic accident is resolved, and the first road link may be included again in the road link candidates after the time the traffic accident is resolved.

As another example, as shown in a view 95 illustrated in FIG. 10, when image data on the first road link is acquired but includes an image on a building 103 located in a place where the road should be, the reason why the first road link is excluded from the road link candidates may be stored as a route data error. In this case, since the route is determined by recognizing a place other than the road as the road, the first road link may be permanently excluded from the road link candidate.

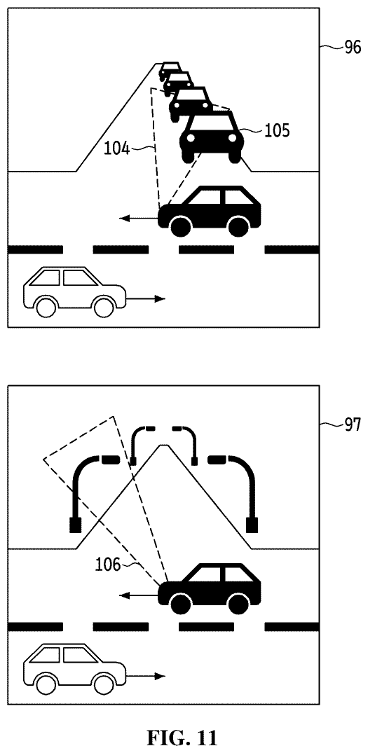

As another example, as shown in a view 96 illustrated in FIG. 11, when image data on the first road link is acquired by photographing a first road but includes an image of a vehicle 105 jammed due to traffic jam, the reason why the first road link is excluded from the road link candidates may be stored as traffic jam. In addition, since the inability to drive on the first road link due to traffic jam is temporary, information on the period during which the first road link is excluded from the road link candidates may be also acquired. For example, using information on the time when traffic jam occurs, the first road link may be excluded from road link candidates during the time of day when traffic jam occurs, and the first road link may be included again in the road link candidates during the remaining time of day. The time when traffic jam occurs may be determined using image data acquired from a plurality of vehicles.

As another example, as shown in a view 97 illustrated in FIG. 11, when image data on the first road link is acquired by photographing 106 a first road but includes an image of a streetlight that is not lit, the reason why the first road link is excluded from the road link candidates may be stored as a failure of a traffic-related facility (e.g., a streetlight, or a traffic light). Furthermore, since the inability to drive on the first road link due to a failure of a traffic-related facility is temporary, information on the period during which the first road link is excluded from the road link candidates may be also acquired. For example, since driving is not hindered by a streetlight failure during the day, the first road link may not be excluded from the road link candidates during the daytime. Additionally, since a streetlight failure at night causes significant inconvenience to driving, the first road link may be excluded from the road link candidates during the night time.

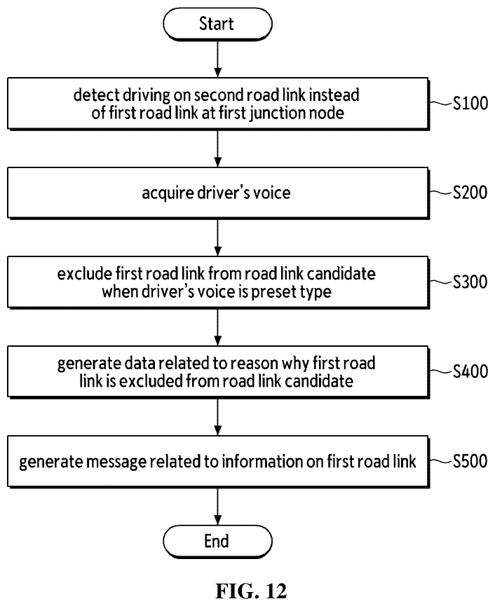

Some embodiments of the present disclosure in which a road link is excluded from road link candidates based on a driver's response and image data have been described as above with reference to FIGS. 3-11. In some embodiments of the present disclosure, it may be determined whether to exclude the corresponding road link from the road link candidates without presenting the driver with a request for confirmation as to whether to exclude the corresponding road link from the road link candidate. An example in which it may be determined whether to exclude the corresponding road link from the road link candidates without presenting the driver with a request for confirmation as to whether to exclude the corresponding road link from the road link candidates, according to some embodiments, is described in more detail below with reference to FIGS. 12-15.

Referring to FIG. 12, in an operation S100, it may be detected that a vehicle drives on the second road link instead of the first road link, that is included in the existing route, at the junction node included in the existing route. The second road link may be a road link that is connected to the junction node and is different from the first road link.

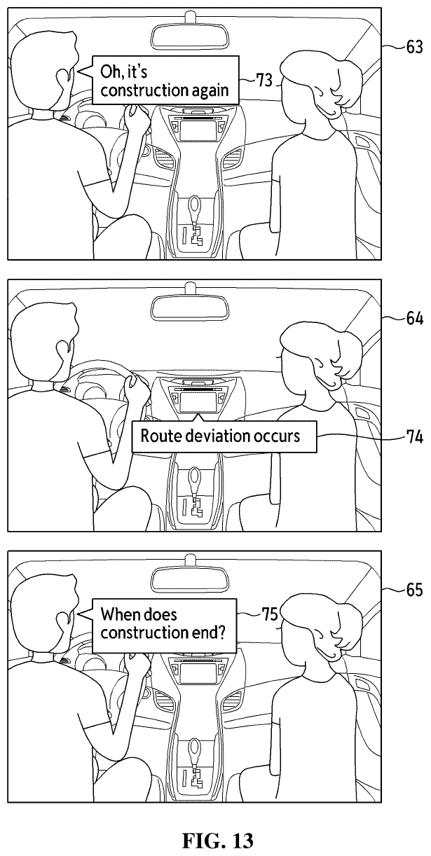

In an operation S200, the driver's voice may be acquired. In an embodiment, the driver's voice may be acquired before and/or after the time point at which the route deviation occurs from the first road link to the second road link. For example, as shown in a view 63 illustrated in FIG. 13, the driver cannot use the road included in the existing route before deviating from the route, and thus may talk (e.g., to himself/herself) by making an utterance 73 such as “Oh, it's construction again.” Also, as shown in a view 65 illustrated in FIG. 13, when the driver cannot use the road included in the existing route after deviating from the route, the driver may talk (e.g., to himself/herself) by making an utterance 75 such as “When does construction end.”

Referring back to FIG. 12, in an operation S300, when the acquired driver's voice utterance is a preset type, the first road link may be excluded from the road link candidates. In an embodiment, as described above, the first road link may be determined to be excluded from the road link candidates by additionally performing a procedure using the confirmation request for the driver or image data on the first road link.

For example, a keyword (e.g., construction, accident, or vehicle jam) related to the reason why the first road link should be excluded from the road link candidates is extracted from the driver's voice, and whether an object (e.g., traffic cone, no-entry sign, no-entry panel, accident vehicle, or jammed vehicle) matching the extracted keyword is included in the image data on the first road link may be confirmed.

In an operation S400, the data related to the reason why the first road link is excluded from the road link candidates may be generated. The data related to the reason why the first road link is excluded from the road link candidates may include the reason (e.g., occurrence of accident, under construction, no road, or traffic jam) why the first road link is excluded from the road link candidates, the period (e.g., 1 hour, 7 days, or 1 month) at which the first road link is excluded from the road link candidates, and the period (e.g., 07:00 to 09:00 every morning) at which the first road link is excluded from the road link candidates.

The data related to the reason why the first road link is excluded from the road link candidates may be generated using the acquired voice data. For example, as in the example 63 shown in FIG. 13, when the driver of the vehicle talks (e.g., to himself/herself) by making the utterance 73 such as “Oh, it's construction again” before the vehicle deviates from the route, the keyword “construction” may be extracted from the driver's voice, and the reason why the first road link is excluded from the road link candidates may be determined as “under construction”.

In some embodiments, the data related to the reason why the first road link is excluded from the road link candidates may be generated using the acquired voice data and the image data on the first road link. For example, as shown in the example 63 illustrated in FIG. 13, when the driver of the vehicle talks (e.g., to himself/herself) by making the utterance 73 such as “Oh, it's construction again” before the vehicle deviates from the route, the keyword “construction” may be extracted from the driver's voice. Afterwards, the image data on the first road link may be acquired. When the image data on the first road link includes an image of an object (e.g., excavator, construction panel, no-entry sign, or traffic cone) related to “construction” which is the keyword, the reason why the first road link is excluded from the road link candidates may be determined as “under construction”.

It should be noted that the voice data is not limited to the voice data acquired from the driver's talking to himself/herself. The voice data may include both voice data acquired from a conversation between the driver and the passenger and voice data acquired from the passenger's talking to himself/herself.

Referring back to FIG. 12, in an operation S500, a message related to information on the first road link may be generated using the data related to the reason why the first road link is excluded from the road link candidates. In an embodiment, the message related to the information on the first road link may be provided to the driver of the vehicle or the passenger of the vehicle.

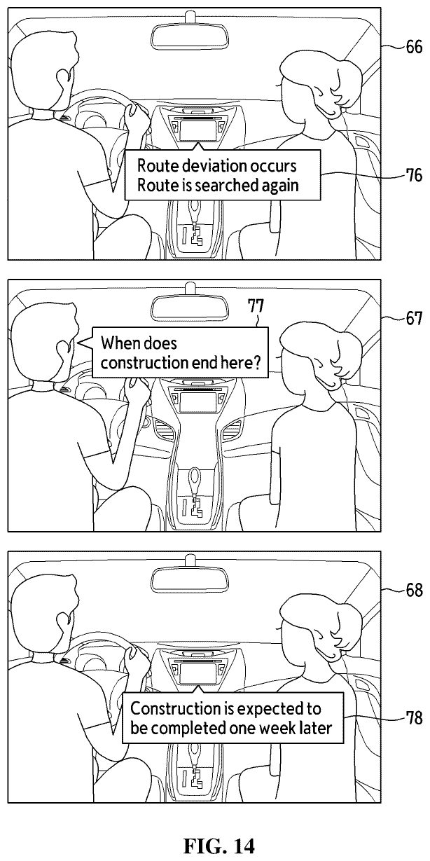

For example, as shown in a view 67 illustrated in FIG. 14, the vehicle deviates from the route by driving on the second road link instead of the first road link, and the driver of the vehicle may utter 77 “When does the construction end here?” to another passenger. The keyword “construction” is extracted from the driver's voice, and the image of the object related to “construction” is confirmed from the image of the first road link, so that the reason why the first road link is excluded from the road link candidates may be determined as “under construction”. Subsequently, in order to generate a message for the driver's voice, image data related to a construction period (e.g. 2024 Dec. 1 to 2024 Dec. 8) may be extracted from the image data on the first road link. A message including information on the construction period may then be generated. As shown in a view 68 illustrated in FIG. 14, a message (e.g. construction is expected to be completed one week later) may be output through the navigation terminal as a voice 78. The message may be displayed and output on the display of the navigation terminal.

In embodiments of the present embodiment, when the vehicle deviates from the route, whether to exclude a road link, on which the vehicle does not drive due to route deviation, from road link candidates may be determined using the voice data acquired from the passenger of the vehicle.

In the above description, for convenience of description, the object of acquiring the voice has been described as the driver. However, the object of acquiring the voice is not limited to the driver, For example, a passenger of the vehicle other than the driver may be the object of acquiring the voice.

The data related to the reason why the first road link is excluded from the road link candidates, that is acquired in the above-described embodiments, may be used in route guidance of a second vehicle different from a first vehicle that generates the data.

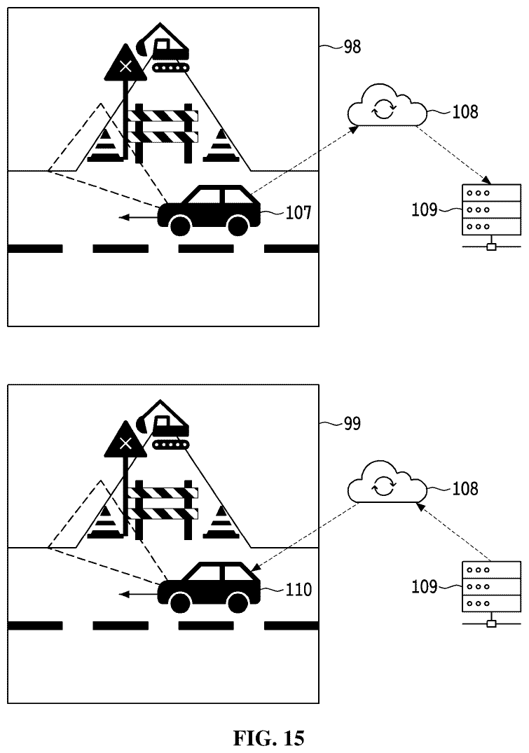

For example, as shown in a view 98 illustrated in FIG. 15, when a first vehicle 107 deviates from the route by not driving on the first road link, image data on the first road link may be acquired in the first vehicle 107, and voice data of the driver of the first vehicle may be acquired. Also, it may be determined that the first road link is to be excluded from the road link candidates, based on the acquired image data and voice data. In an embodiment, data related to the reason why the first road link is excluded from the road link candidates may be generated based on the acquired image data and voice data. The data related to the reason why the first road link is excluded from the generated road link candidates may be transmitted to a server 109 through a network 108.

As shown in a view 99 illustrated in FIG. 15, when a second vehicle 110 drives toward the same destination as that of the first vehicle 107, a route including a second road link different from the first road link may be provided. In this case, the route including the second road link and not including the first road link is provided, and the data related to the reason why the first road link is excluded may be transmitted from the server 109 through the network 108. When passing through the first road link, a message (e.g. construction is expected to be completed one week later) related to the first road link may be automatically generated and output in the second vehicle 110. Also, in response to the voice (e.g., “When does the construction end here?”) of the driver or passenger of the second vehicle 110, a message (e.g., the construction is expected to be completed one week later) related to the first road link may be generated and output.

Example embodiments in which whether to exclude a road link from road link candidates without presenting a driver with a request to confirm whether to exclude the road link from the road link candidates may be determined, have been described as above with reference to FIGS. 12-15.

In some embodiments of the present disclosure, the user (e.g., the driver or the passenger) may be allowed to easily report a traffic situation by utilizing the voice recognition technology, so that convenience and accessibility of the reporting process may be greatly improved. In particular, since the user may quickly and intuitively report the road condition with only a voice command without a complicated procedure or additional input, efficiency of collecting real-time traffic information is increased. Accordingly, information on an urgent situation such as an accident or an obstacle may be quickly transmitted, thereby contributing to enhancing road safety.

Also, in some embodiments of the present disclosure, the road condition may be analyzed based on the image recognition technology and the route data, and the user response to the corresponding data may be requested, so that accurate and reliable traffic information may be provided. In some embodiments of the present disclosure, traffic flow and obstacles may be analyzed in real time based on self-collected data (e.g., road image, and voice of the driver or the passenger) without simply relying on the user's report, thereby making active reaction to the traffic flow and obstacles. As a result, traffic information may be provided to vehicles that use the same navigation system, in real time, so that an optimal route may be provided to all vehicles that use the same navigation system, in real time.

The effects according to the technical spirits of the present disclosure are not limited to those mentioned above, and other effects not mentioned should be more clearly understood by those having ordinary skill in the art from the contents of the present disclosure.

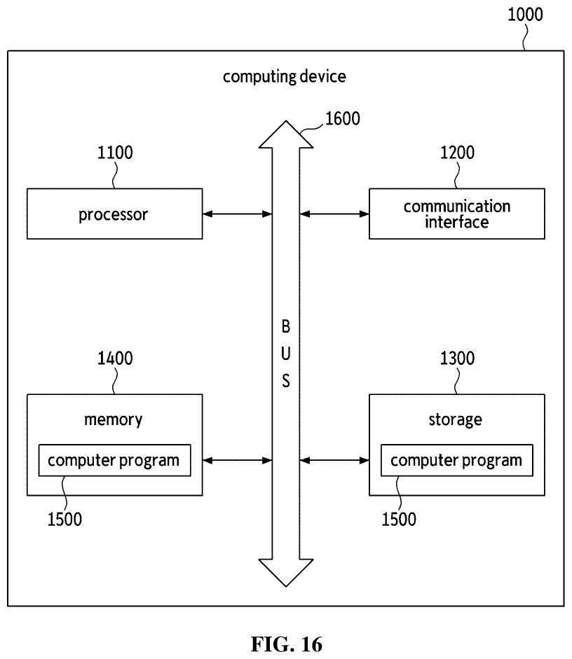

Hereinafter, a hardware configuration of an example computing device according to some embodiments of the present disclosure is described with reference to FIG. 16. The computing device may be a computing device (e.g., a navigation terminal, a computer, or a smartphone) in which the navigation terminal or the navigation server of the present disclosure is implemented.

FIG. 16 is a block diagram illustrating a hardware configuration in which a computing device may be implemented in various embodiments of the present disclosure. A computing device 1000 according to an embodiment may include one or more processors 1100, a system bus 1600, a communication interface 1200, a memory 1400 for loading a computer program (e.g., in the form of computer-readable instructions) 1500 executed by the processor 1100, and a storage 1300 for storing the computer program 1500. In FIG. 16, only components related to embodiments of the present disclosure are shown. Accordingly, it should be apparent to those having ordinary skill in the art to which the present disclosure pertains that the computing device may further include other general-purpose components in addition to the components shown in FIG. 16.

The processor 1100 controls the overall operation of each component of the computing device 1000. The processor 1100 may include at least one of a central processing unit (CPU), a microprocessor unit (MPU), a micro controller unit (MCU), a graphic processing unit (GPU), or any type of processor well known in the technical field of the present disclosure. In addition, the processor 1100 may perform computation on at least one application or program for executing an operation/method according to various embodiments of the present disclosure. The computing device 1000 may include one or more processors.

The memory 1400 stores various types of contents, commands and/or information. The memory 400 may load one or more programs 1500 from the storage 1300 to execute the methods/operations according to various embodiments of the present disclosure. An example of the memory 1400 may be RAM, but is not limited thereto. The system bus 1600 provides a communication function between components of the computing device 1000.

The system bus 1600 may be implemented as various types of buses such as an address bus, a data bus, and a control bus. The communication interface 1200 supports wired/wireless Internet communication of the computing device 1000. The communication interface 1200 may support various communication methods other than Internet communication. To this end, the communication interface 1200 may be configured to include a communication module well known in the technical field of the present disclosure. The storage 1300 may non-temporarily store one or more computer programs 1500. The storage 1300 may include a nonvolatile memory such as a flash memory, a hard disk, a detachable disk, or any type of computer-readable recording medium well known in the art to which the present disclosure pertains.

The computer program 1500 may include one or more instructions in which methods/operations according to various embodiments of the present disclosure are implemented. When the computer program 1500 is loaded into the memory 1400, the processor 1100 may perform the methods/operations according to various embodiments of the present disclosure by executing one or more instructions.

For example, the computer program 1500 may include instructions to perform operations including: detecting that a vehicle drives on a second road link, different from a first road link, instead of driving on the first road link included in an existing route at a first junction node included in the existing route; requesting a user of a navigation device of the vehicle to confirm whether the first road link should be excluded from road link candidates available for selection in determining routes; and determining whether to exclude the first road link from the road link candidates based on image data on the first road link, in response to receiving a response, from the user, indicating that the first road link should be excluded from the road link candidates.

As another example, the computer program 1500 may include instructions to perform operation including: detecting that a vehicle drives on a second road link, different from a first road link, instead of driving on the first road link included in an existing route, at a first junction node included in the existing route; acquiring a voice of a user of a navigation device of the vehicle; and excluding the first road link from road link candidates available for selection in determining routes, based on determining the voice is a preset type of voice.

What is claimed is:

1. A method for collecting route data, the method comprising:
detecting that a vehicle drives on a second road link, instead of driving on a first road link included in an existing route provided by a navigation device, based on detecting that the vehicle passes through a first junction node included in the existing route;
requesting a user of the navigation device to confirm whether the first road link should be excluded from road link candidates available for selection in determining routes; and
determining whether to exclude the first road link from the road link candidates, based on a response to the request received from the user.

2. The method of claim 1, wherein requesting the user to confirm whether the first road link should be excluded from the road link candidates includes requesting a driver of the vehicle to confirm whether the first road link should be excluded from the road link candidates, based on determining that a number of times that the vehicle drives on the second road link instead of the first road link at the first junction node is greater than or equal to a preset number of times.

3. The method of claim 1, wherein determining whether to exclude the first road link from the road link candidates includes:
acquiring image data on the first road link; and
determining to exclude the first road link from the road link candidates based on determining that the acquired image data includes an object of a preset type.

4. The method of claim 1, wherein determining whether to exclude the first road link from the road link candidates includes:
acquiring image data on the first road link; and
determining to exclude the first road link from the road link candidates based on comparing the acquired image data with reference image data on the first road link.

5. The method of claim 4, wherein the reference image data on the first road link includes image data acquired at a time when the vehicle drives on the first road link.

6. The method of claim 1, further comprising:
generating information related to a reason why the first road link is excluded from the road link candidates, based on the acquired image data on the first road link; and
adding information related to the reason why the first road link is excluded from the road link candidates to data on the first road link.

7. A method for collecting route data, the method comprising:
detecting that a vehicle drives on a second road link, different from a first road link, instead of driving on the first road link included in an existing route provided by a navigation device, at a first junction node included in the existing route provided by the navigation device;
acquiring a voice utterance of a user of the navigation device; and
excluding the first road link from road link candidates available for selection in determining routes, based on determining that the voice utterance includes an utterance of a preset type.

8. The method of claim 7, wherein acquiring the voice utterance of the user of the navigation device includes acquiring a voice utterance of a driver of the vehicle within a preset time from a time of detecting that the vehicle has not entered the first road link.

9. The method of claim 7, wherein acquiring the voice utterance of the user of the navigation device includes acquiring the voice utterance of the user of the navigation device before detecting that the vehicle has not entered the first road link.

10. The method of claim 7, further comprising:
detecting that the vehicle has not entered the first road link after the first road link is excluded from the road link candidates; and
generating a message including information on the first road link.

11. The method of claim 7, wherein excluding the first road link from the road link candidates includes:
acquiring image data on the first road link; and
excluding the first road link from the road link candidates when the voice utterance of the user matches the image data.

12. The method of claim 11, further comprising:
acquiring data on the first road link based on the image data; and
generating a message including information on the first road link based on the data on the first road link.

13. The method of claim 7, further comprising generating data related to a reason why the first road link is excluded from the road link candidates, based on the voice utterance of the user.

14. An apparatus for collecting route data, the apparatus comprising:
a communication interface;
a memory configured to store computer-readable instructions; and
one or more processors configured to execute the computer-readable instructions,
wherein the computer-readable instructions, when executed by the one or more processors, cause the one or more processors to:
detect that a vehicle drives on a second road link, different from a first road link, instead of driving on the first road link included in an existing route provided by a navigation device, at a first junction node included in the existing route provided by the navigation device,
request a user of the navigation device to confirm whether the first road link should be excluded from road link candidates available for selection in determining routes; and
determine whether to exclude the first road link from the road link candidates, based on image data on the first road link, in response to receiving a confirmation, from the user, indicating that the first road link should be excluded from the road link candidates.
